(19) United States
(12) Patent Application Publication
(10) Pub. No.: US 2014/0069283 A1
(43) Pub. Date: Mar. 13, 2014

(54) OVEN HAVING PRODUCT REMOVAL DEVICE

(71) Applicants: Johannes Haas, Wien (AT); Josef Haas, Leobendorf (AT); Stefan Jiraschek, Koenigsbrunn (AT); Fritz Obermaier, Krems (AT)

(72) Inventors: Johannes Haas, Wien (AT); Josef Haas, Leobendorf (AT); Stefan Jiraschek, Koenigsbrunn (AT); Fritz Obermaier, Krems (AT)

(73) Assignee: HAAS FOOD EQUIPMENT GMBH, Wien (AT)

(21) Appl. No.: 14/116,265

(22) PCT Filed: May 4, 2012
(86) PCT No.: PCT/EP2012/058212

§ 371 Date: Nov. 7, 2013

(30) Foreign Application Priority Data
May 11, 2011 (AT) A671/2011

(51) Int. Cl. A21B 1/46; A21B 3/18; A21B 3/07

(52) U.S. Cl. CPC A21B 1/46; A21B 3/07; A21B 3/18
USPC 99/427

(57) ABSTRACT

A baking oven has an endless baking tong chain having openable and closable baking tongs circulating in the baking oven and moving in two transport levels disposed one above the other through a baking chamber. In the front oven part, a device for opening the baking tongs, an output station, a loading station and a device for closing the baking tongs are disposed consecutively in a running direction of the baking tongs along the upper transport level. Located in the output station is a product removal apparatus having a horizontally disposed rotary framework which carries removal elements configured as suction elements disposed along its outer circumference, by way of which the rotating rotary framework removes the baked products from the opened baking tongs.

The invention relates to baking ovens having an endless baking tong chain circulating in the baking oven, which contains baking moulds consisting of baking mould upper parts and baking mould lower parts in the openable and closable baking tongs thereof, in which baked products produced by a baking process are formed.

The baking ovens each have a front oven part, a rear oven part, an oven frame provided with an external thermal insulation, a baking chamber disposed inside the thermal insulation and an endless baking tong chain circulating continuously in the baking oven and moving through the baking chamber. The baking tong chain is disposed in the baking oven along an orbit which is closed in itself and which extends in two transport levels disposed one above the other through both oven parts. The baking tong chain contains openable and closable baking tongs in which baking moulds consisting of baking mould upper parts and baking mould lower parts are disposed, which moulds are opened by opening the baking tongs and which are closed by closing the baking tongs. In the front oven part of the baking oven, a device for opening the baking tongs, an output station, a loading station and a device for closing the baking tongs are disposed along the upper transport level consecutively in the running direction of the baking tongs. Located in the output station is a product removal apparatus which removes the baked products from the opened baking tongs and which is followed by an upper transport device for the removed baked products.

In these baking ovens, flowable baking preparations are processed and converted into baked products by a baking process.

The baking preparations are produced in a mixer. In the mixer the liquid ingredients of the baking preparation and the solid or powdery ingredients of the baking preparation are mixed with one another. A shapeless mass is thereby produced. The shapeless mass is flowable. It has a liquid, i.e. thin-liquid to thick-liquid, and sometimes mushy consistency. The liquid ingredients are principally water comprising a proportion of 42.0 to 60.0 wt. % of the baking preparation. The powdery ingredients are principally a starch-containing principal component comprising a proportion of 36.0 to 56.5 wt. % of the baking preparation. Mostly wheat flour is used as the starch-containing principal component. The starch-containing principal component can also be a starch flour or a mixture of wheat flour and starch flour, or a mixture of different cereal or starch flours.

The baked products produced from such baking preparations can be edible baked products such as, for example, wafers, waffles, soft waffles, pancakes etc.

However, the baked products produced from such baking preparations can also be other products not provided for consumption per se. These products include, e.g. packaging articles such as, for example, packaging cups made from a starch-containing baking preparation or parts of disposable tableware such as, for example, plates and cups and also knives, forks and spoons, made of a starch-containing baking preparation.

The baking preparations are supplied to the baking oven as shapeless, liquid to mushy masses. In the baking oven the shapeless mass is conveyed by means of a dough pump through dough lines to the loading station. In the loading station the shapeless mass is divided into dough portions and the dough portions are introduced into the opened baking moulds which are disposed in the opened baking tongs which pass through the loading station in the upper transport level of the baking oven. After introducing the dough portions, the baking tongs are closed. On closing the baking tongs, the baking moulds are closed and the dough portions are enclosed in the closed baking moulds. The circulating baking tong chain conveys the closed baking tongs through the baking chamber into the rear oven part and through the baking chamber. Whilst the baking tongs pass through the baking chamber, the baking tongs together with the baking moulds are heated and thereby heated to baking temperatures between 150° C. (degrees Celsius) and 250° C. (degrees Celsius). In the closed baking tongs the dough portions enclosed in the baking moulds are subjected to a baking process and are baked in a pressureless manner in the closed baking moulds. As a result of the baking process a baked product is formed in each baking mould which remains in the closed baking tongs. The circulating baking tong chain conveys the closed baking tongs in the front oven part into the upper transport level. During passage through the upper transport level the baking tongs are opened and conveyed in the opened state through the output station to the input station. In the output station the baked products are removed in the hot state from the opened baking moulds which are disposed in the opened baking tongs. The baked products are output from the baking oven in the hot state. The circulating baking tong chain conveys the opened baking tongs with the opened empty baking moulds to the loading station. In the loading station, dough portions formed from the shapeless mass are introduced anew into the opened baking moulds.

Baking ovens in which the baking moulds consisting of baking mould upper parts and baking mould lower parts are disposed in the openable and closable baking tongs of an endless baking tong chain circulating in the baking oven and moving through the baking chamber are known, for example, from the documents AT 506 418 A1, WO 2009/100873 A2 and US 2009/200291 A1.

It is the object of the invention to improve a baking oven of the type mentioned initially.

A new baking oven is proposed according to the invention. The new baking oven has a front oven part, a rear oven part, an oven frame provided with an external thermal insulation, a baking chamber disposed inside the thermal insulation and an endless baking tong chain circulating continuously in the baking oven and moving through the baking chamber. The baking tong chain is disposed in the baking oven along an orbit which is closed in itself and which extends in two transport levels disposed one above the other through both oven parts. The baking tong chain contains openable and closable baking tongs in which baking moulds consisting of baking mould upper parts and baking mould lower parts are disposed, which are opened by opening the baking tongs and which are closed by closing the baking tongs. In the front oven part of the baking oven, a device for opening the baking tongs, an output station, a loading station and a device for closing the baking tongs are disposed along the upper transport level consecutively in the running direction of the baking tongs. Located in the output station is a product removal apparatus which removes the baked products from the opened baking tongs and which is followed by an upper transport device for the removed baked products.

According to the invention, the new baking oven is characterised in that the product removal apparatus has a horizontally disposed rotary framework which is rotatable about a horizontal axis of rotation, which projects into the opened baking tongs, that the rotary framework carries removal elements disposed along its outer circumference, which are disposed consecutively on the outer circumferences of the rotary framework in at least one longitudinal row extending along the circumference of the rotary framework and that the removal elements are configured as suction elements connected to a negative pressure source.

In this baking oven it can be further provided according to the invention that the horizontally disposed rotary framework is disposed in a height-adjustable manner in the front oven part. Furthermore, the horizontally disposed rotary framework can have outwardly projecting drive lugs on its outer circumference, which in the baking tong chain engage in intermediate spaces disposed between the baking tongs of the baking tong chain.

In the baking oven according to the invention, the baked products formed in the closed baking tongs are removed from the circulating, opened baking tongs at the output station of the baking oven. The baked products lie in the opened baking tongs on the baking mould lower parts of the opened baking moulds disposed in the tong lower parts of the baking tongs.

Removal is accomplished by the product removal apparatus or by the horizontally disposed rotating rotary framework of the product removal apparatus. The horizontally disposed rotary framework rotates about its horizontally disposed central axis and removes the baked products from the opened baking tongs without deforming the baked products.

The rotating rotary framework grips the product pieces lying on the baking mould lower parts with its removal elements. The removal elements of the rotary framework are configured as suction elements which are connected to a negative pressure source. The negative pressure generated by a negative pressure source acts via the removal elements of the rotary framework configured as suction elements directly on the product pieces lying on the baking mould lower parts. The product pieces are gripped individually. Each product piece is initially gripped by at least one suction element and held firmly on the rotary framework. The product piece is removed from the opened baking tongs by the turning movement of the rotary framework and conveyed by the turning movement of the rotary framework to the upper transport device. The product piece is gripped by means of the negative pressure applied at the suction element. Upon transfer of the product piece to the upper transport device, the negative pressure acting on the product piece via the suction element is interrupted.

According to the invention, the horizontally disposed rotary framework can be arranged in a height-adjustable manner in the front oven part. The configuration enables the position of the horizontal axis of rotation of the rotary framework inside the oven frame to be changed. As a result, on the underside of the rotary framework the distance between the removal elements disposed on the circumference of the rotating rotary framework and the horizontally disposed tong lower parts of the opened baking tongs can be adjusted or modified.

The height-adjustable arrangement of the rotary framework allows the height position of the rotary framework on the upper sides of the baked products to be adjusted, which in the opened baking tongs lie on the baking mould lower parts disposed in the tong lower parts of the baking tongs.

According to the invention, the horizontally disposed rotary framework can have outwardly projecting drive lugs on its outer circumference, which in the circulating baking tong chain engage in intermediate spaces disposed between the baking tongs of the baking tong chain. This configuration provides a direct driving of the horizontally disposed rotary framework by the baking tong chain circulating in the baking oven, which is driven and set in motion by the main drive of the baking oven.

According to a further feature of the invention, it can be provided that the rotary framework has at least two product carrying arms which are disposed along the circumference of the rotary framework at a distance from one another, and that each product carrying arm carries at least one removal element configured as a suction element.

The rotary framework is assigned with its product carrying arms to the baked product pieces which are disposed in the tong lower parts of the opened baking tongs which pass successively through the output station of the baking oven. Each product carrying arm is assigned to one product piece. The product carrying arm grips the product piece with its removal element configured as a suction element. The product piece is removed from the opened baking tongs by the turning movement of the rotary framework and is conveyed to the upper transport device.

The rotary framework can have product carrying arms disposed one behind the other in the direction of rotation, which are assigned to the product pieces disposed one behind the other in the tong lower part of an opened baking tong.

According to a further feature of the invention, it can be provided that the product carrying arm has at least one rod which carries at least two removal elements configured as suction elements which are disposed along the rod at a distance from one another. In this configuration each product piece is gripped by two or more removal elements of a product carrying arm configured as a suction element and is held firmly on the rotary framework by negative pressure. The product piece rests on the product carrying arm and is removed from the opened baking tong by the turning movement of the rotary framework.

According to a further feature of the invention, it can be provided that the product carrying arm has at least one longitudinal rod disposed parallel to the axis of rotation of the rotary framework, which carries at least one removal element configured as a suction element. In this configuration, the product carrying arms disposed at a distance from one another along the circumference of the rotary framework are aligned parallel to the axis of rotation of the rotary framework.

According to a further feature of the invention, it can be provided that the longitudinal rod of the product carrying arm parallel to the axis of rotation of the rotary framework carries at least two removal elements configured as suction elements, which are disposed along the longitudinal rod at a distance from one another.

This configuration of the rotary framework allows a single wide product piece or two adjacently disposed product pieces to be removed from a tong lower part of an opened baking tong with a single product carrying arm.

According to a further feature of the invention, it can be provided that the product carrying arm has at least two longitudinal rods disposed parallel to the axis of rotation of the rotary framework, which are disposed in a reference plane parallel to the axis of rotation of the rotary framework and that the longitudinal rods carry removal elements configured as suction elements, which are disposed perpendicular to the reference plane.

This configuration of the rotary framework is advantageous for the manipulation of plate-shaped product pieces which are gripped by the two longitudinal rods of the product carrying arm in each case close to the front or rear edge of the product piece. The product carrying arm can also have three or more longitudinal rods each carrying a plurality of removal elements configured as suction elements, which are disposed along the respective longitudinal rod at a distance from one another and which are each disposed perpendicular to the reference plane formed by the longitudinal rods.

According to a further feature of the invention, it can be provided that the product carrying arm has a longitudinal rod disposed parallel to the axis of rotation of the rotary framework, which carries at least one transverse rod disposed transversely to the longitudinal rod, which is disposed in a reference plane parallel to the axis of rotation of the rotary framework, and that the transverse rod carries two or more removal elements configured as a suction element, which are disposed along the transverse rod at a distance from one another and which are each disposed perpendicular to the reference plane.

This configuration is advantageous for the manipulation of wide product pieces. These are each gripped at two or more places by the product carrying arm and hold the removal elements configured as suction elements firmly on the transverse rod of the product carrying arm.

According to a further feature of the invention, it can be provided that in a product carrying arm of the rotary framework provided with a longitudinal rod, the longitudinal rod carries two or more transverse rods disposed at a distance from one another, which are disposed in a reference plane parallel to the axis of rotation of the rotary framework, and that each transverse rod carries at least two removal elements configured as a suction element, which are disposed along the transverse rod at a distance from one another and are in each case disposed perpendicular to the reference plane.

This configuration is advantageous for the manipulation of large plate-shaped product pieces. The product carrying arm grips each product piece at several places simultaneously. The removal elements configured as suction elements and exposed to negative pressure hold the product piece firmly on the transverse rods of the product carrying arm. The product piece held firmly on the product carrying arm is removed from the opened baking tong by the turning movement of the rotary framework.

According to a further feature of the invention, it can be provided that in a product carrying arm of the rotary framework the product carrying arm has at least two longitudinal rods disposed parallel to the axis of rotation of the rotary framework, which are disposed in a reference plane parallel to the axis of rotation of the rotary framework, and that the product carrying arm has at least two transverse rods disposed transversely to the longitudinal rods, which each carry at least two removal elements configured as a suction element, which are disposed along the transverse rod at a distance from one another and are disposed in each case perpendicular to the reference plane.

This configuration is advantageous in the manipulation of large, plate-shaped product pieces. For the manipulation of very large plate-shaped product pieces three, four, five or even more transverse rods disposed at a distance from one another can be attached to the longitudinal rods of the product carrying arm, which are each disposed parallel to the reference plane. Each transverse rod can carry three, four, five or even more removal elements configured as suction elements, arranged at a distance from one another, which are each aligned perpendicular to the reference plane parallel to the transverse rods. The product piece gripped by this product carrying arm rests on the transverse rods of the product carrying arm. The negative pressure applied to the product piece via the removal elements configured as suction elements attached to the transverse rods holds the product piece firmly on the product carrying arm. The product piece is removed from the opened baking tongs by the turning movement of the rotary framework.

According to a further feature of the invention, it can be provided that the product-carrying arms are configured as hollow profiles and form a part of the suction lines which lead from the removal elements configured as suction elements, which are attached to the product-carrying arms to a negative pressure source. In this configuration of the rotary framework, the suction lines, which lead from the removal elements configured as suction elements to the negative pressure source, run inside the hollow rods of the product-carrying arms.

According to a further feature of the invention, it can be provided that the removal elements disposed on the circumference of the rotary framework are configured as suction cups preferably each provided with an elastic bellows, which are attached to the product carrying arms and are connected via suction lines to a negative pressure source.

According to a further feature of the invention, it can be provided that the removal elements disposed on the circumference of the rotary framework are configured as suction sleeves which can be compressed elastically into themselves, which are attached to the product carrying arms and are connected via suction lines to a negative pressure source.

According to a further feature of the invention, it can be provided that the horizontally disposed rotary framework has at least one vertically disposed rotary star which carries the removal elements configured as suction elements, which are disposed on the circumference of the rotary framework.

In this configuration of the rotary framework, the product pieces are removed from the opened baking tongs by the vertically disposed rotary star of the rotating rotary framework. The removal elements configured as suction elements attached to the rotary star are each exposed to negative pressure. The product pieces are gripped by the removal elements by means of negative pressure and held firmly on the rotary star by means of negative pressure. The product pieces are removed from the opened baking tongs by the turning movement of the rotary star and conveyed to the upper transport device downstream of the rotary framework.

According to the invention, the horizontally disposed rotary framework can have two or more rotary stars disposed adjacent to one another at a distance, which carry removal elements configured as suction elements, which are disposed on the circumference of the rotary framework.

In this configuration, the removal elements of the rotary framework configured as suction elements are disposed on the outer side of the rotary stars. The removal elements are disposed on the outer sides of the rotary stars in longitudinal rows extending along the circumference of the rotary star. At the same time the removal elements are disposed in transverse rows parallel to the axis of rotation of the rotary framework. With the adjacently disposed rotary stars, individual large-area product pieces or adjacently disposed smaller product pieces can be removed from the opened baking tongs.

According to a further feature of the invention, it can be provided that the vertically disposed rotary star has an outer circumference configured as a polygon, in which the removal elements configured as suction elements are disposed on the straight segments of the outer rim.

According to a further feature of the invention, it can be provided that respectively at least two removal elements configured as suction elements are disposed at a distance from one another on the straight segments of the outer rim.

According to a further feature of the invention, it can be provided that the rotary star is configured as a hollow body and forms part of the suction line which leads from the removal elements configured as suction elements to a negative pressure source.

According to a further feature of the invention, it can be provided that the removal elements of the rotary framework configured as suction elements are preferably configured as suction cups each provided with an elastic bellows, which are attached to the outer circumference of the rotary star and are connected to a negative pressure source via suction lines.

According to a further feature of the invention, it can be provided that the removal elements of the rotary framework configured as suction elements are configured as suction sleeves which can be compressed laterally into themselves, which are attached to the outer circumference of the rotary star and are connected to a negative pressure source via suction lines.

The invention is explained in detail hereinafter by exemplary embodiments with reference to the drawings. In the drawings:

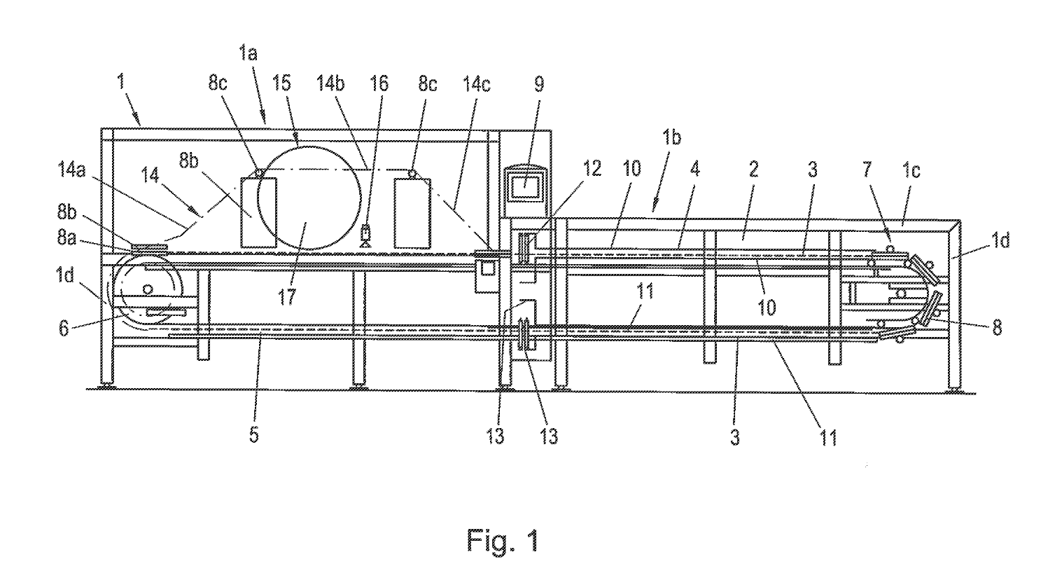

FIG. 1 shows schematically a first baking oven from the side,

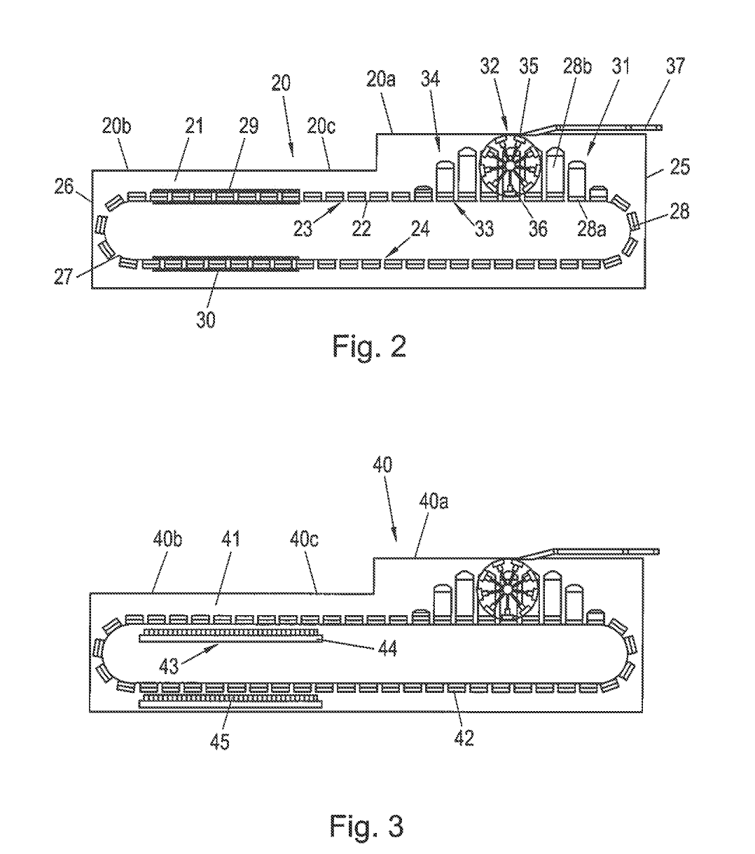

FIG. 2 shows schematically a second baking oven from the side,

FIG. 3 shows schematically a third baking oven from the side,

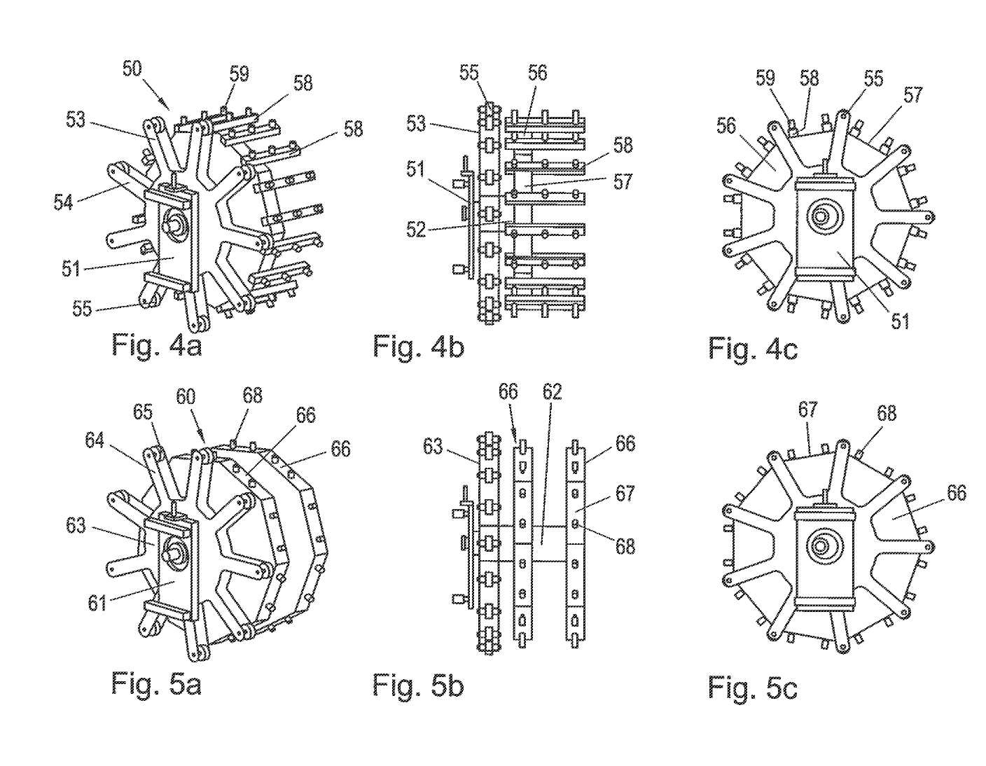

FIGS. 4a to 4c show a first rotary framework,

FIGS. 5a to 5c show a second rotary framework,

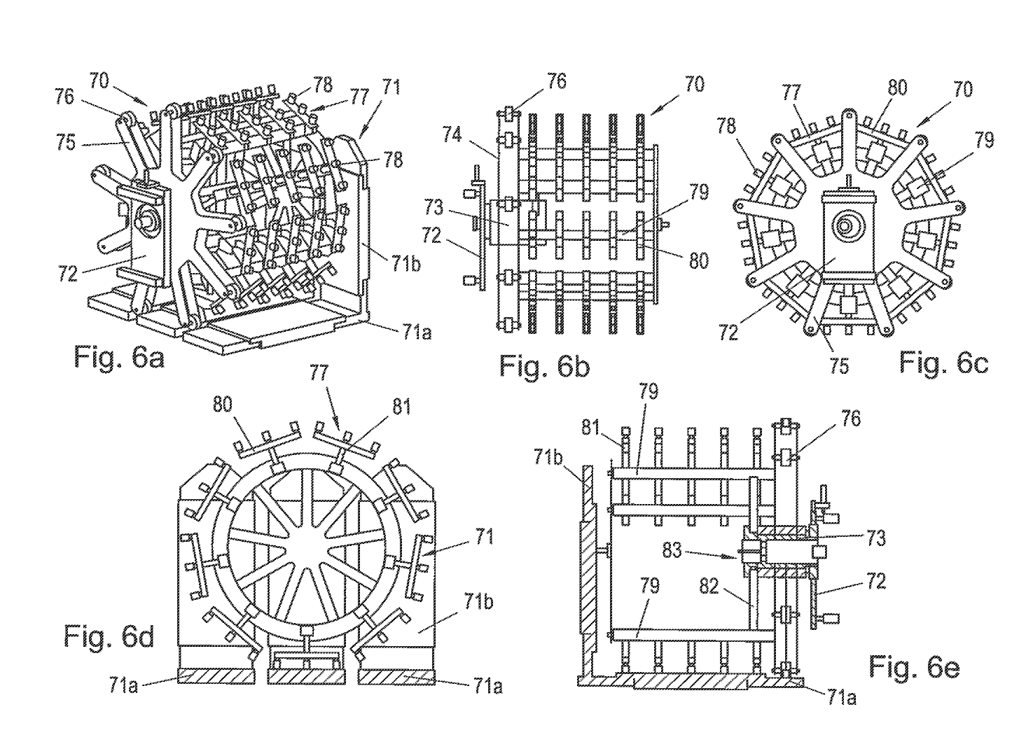

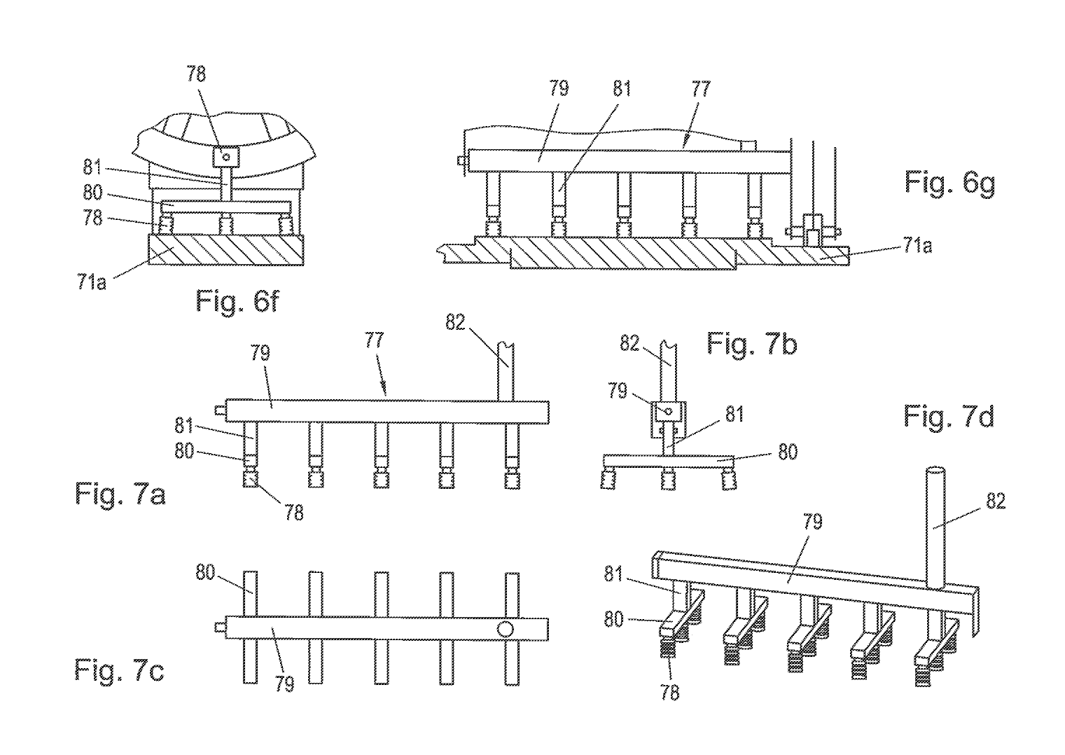

FIGS. 6a to 6g show a third rotary framework,

FIGS. 7a to 4d show a product carrying arm,

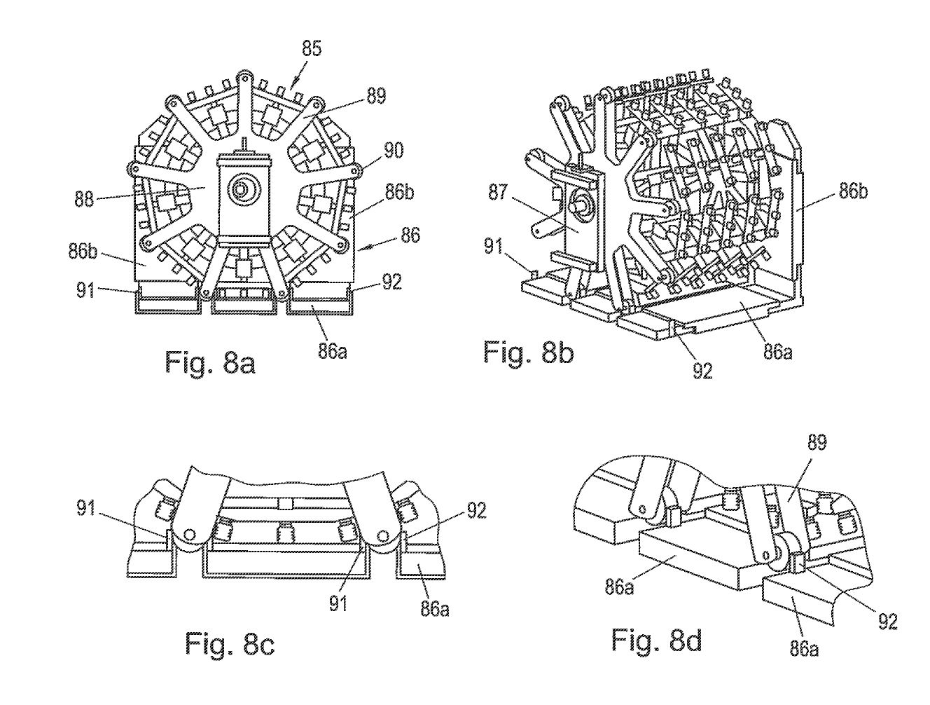

FIGS. 8a to 8c show another rotary framework,

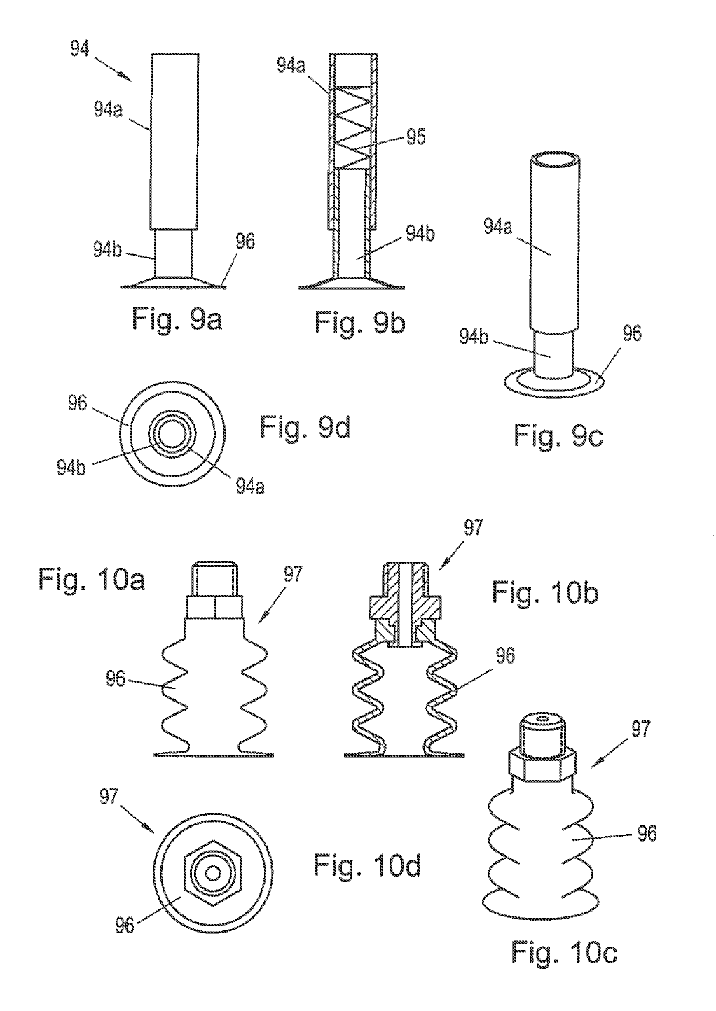

FIGS. 9a to 9d show a first removal element and

FIGS. 10a to 10d show a second removal element.

FIG. 1 shows schematically a first baking oven 1 from the side. The baking oven 1 has a first front oven part 1a, a rear oven part 1b, an oven framework 1d provided with an external thermal insulation 1c, furthermore a baking chamber 2 disposed inside the thermal insulation and an endless baking tong chain 3 circulating continuously in the baking oven 1 and moving through the baking chamber 2. The endless baking tong chain 3 is disposed along an orbit which is closed in itself in the baking oven 1, which extends in two superposed transport levels 4 and 5 through both oven parts 1a and 1b. The baking tong chain 3 is driven by a drive wheel 6 disposed near the front end of the baking oven 1 and is deflected by the drive wheel 6 from the lower transport level 5 upwards into the upper transport level 4. The circulating baking tong chain 3 is moved in the upper transport level 4 away from the drive wheel 6 towards the rear. Near the rear end of the baking oven 1 the baking tong chain 3 passes a rear baking tong chain deflecting device 7. At the deflecting device 7, the baking tong chain 3 is deflected from the upper transport level 4 downwards into the lower transport level 5.

The baking tong chain 3 contains openable and closable baking tongs 8. The baking tongs 8 are disposed one behind the other in the baking tong chain 3. Located in the baking tongs 8 are baking moulds consisting of baking mould upper parts and baking mould lower parts which are opened by opening the baking tongs 8 and closed by closing the baking tongs 8. The baking tongs 8 each have a tong lower part 8a and a tong upper part 8b which is pivotably connected to said tong lower part. Attached to the tong upper part 8b is a control roller 8c by which means the baking tongs 8 are opened and closed. Flat baking plates which contain the baking mould lower parts of the baking moulds are disposed in the tong lower parts 8a. Flat baking plates which contain the baking mould upper parts of the baking moulds are disposed in the tong upper parts 8b.

The baking oven 1 is provided with an electrical induction heater. This provides an alternating current generator 9 disposed adjacent to the front oven part 1a and elongate inductors 10, 11 disposed in the baking chamber 2. The alternating current generator 9 is connected via current lines 12, 13 to the inductors 10, 11 and supplies these with current. The elongate inductors 10, 11 are disposed in the baking chamber 2 above and below the orbit of the baking tong chain 3. The flat baking plates contained in the baking tongs 8 are configured as susceptor plates which are inductively heated in a non-contact manner by the magnetic fields generated by the inductors 10, 11.

In the front oven part 1a a linkage 14 is provided for engagement with the control rollers 8c of the baking tongs 8 along the upper transport level 4. The linkage 14 provides three successive sections in the running direction of the baking tongs 8. The linkage 14 provides a gradually ascending linkage section 14a, which forms a device for opening the baking tongs 8. The linkage section 14a is adjoined by an upper horizontal linkage section 14b. This holds the opened baking tongs 8 in the opened state whilst they pass through the output station 15 of the baking oven 1 and the loading station 16 adjoining this. The linkage section 14b is adjoined by a gradually descending linkage section 14c which forms a device for closing the baking tongs 8.

A product removal apparatus 17 which projects into the opened baking tongs 8 and is shown only schematically in FIG. 1 is provided in the output station 15. The product removal apparatus 17 removes the baked products from the tong lower parts 8a of the opened baking tongs 8 and transfers them to an upper transport device not shown in FIG. 1, from which the baked products are conveyed out from the baking oven 1.

During operation of the baking oven 1 in the loading station 16 a baking preparation is introduced in individual dough portions into the circulating opened baking tongs 8. After leaving the loading station 16 the baking tongs 8 with their control rollers 8c move along the gradually descending linkage section 14c. In so doing, the tong upper parts 8b are folded downwards to the tong lower parts 8a and the baking tongs 8 are closed. During closure of the baking tongs 8 the baking moulds contained in the baking tongs 8 are closed and the dough portions enclosed in the closed baking moulds. The closed baking tongs 8 are conveyed by the circulating baking tong chain 3 through the baking chamber 2. In the baking chamber 2 the baking moulds are heated inductively in a non-contact manner and the dough portions enclosed in the baking moulds are baked. The closed baking tongs 8 are conveyed with the baked dough portions contained therein by the circulating baking tong chain 3 in the lower transport level 5 in the baking oven 1 forwards to the drive wheel 6. The baking tongs 8 are conveyed along the drive wheel 6 into the upper transport level 4. In the upper transport level 4 the baking tongs 8 with their control rollers 8c move along the gradually ascending linkage section 14a. The baking tongs 8 are thereby opened and the tong upper parts 8b are folded up. The baked dough portions or the baked products remain in the tong lower parts 8a of the opened baking tongs 8. The baked products are removed in the output station 15 by the product removal apparatus 17 from the tong lower parts 8a of the opened baking tongs 8.

FIG. 2 shows schematically a second baking oven 20 from the side. The baking oven 20 has a front oven part 20a, a rear oven part 20b, an oven frame provided with an external thermal insulation 20c, a baking chamber 21 disposed inside the thermal insulation 20c and an endless baking tong chain 22 circulating continuously in the baking oven 20 and moving through the baking chamber 21. The baking tong chain 22 is disposed along an orbit which is closed in itself in the baking oven 20, which extends in two superposed transport levels 23 and 24 through both oven parts 20a and 20b. The baking tong chain 22 is driven by a drive wheel not shown in FIG. 2, disposed near the front end 25 of the baking oven 20 and is deflected by the drive wheel from the lower transport level 24 upwards into the upper transport level 23. The circulating baking tong chain 22 is moved in the upper transport level 23 from the front end 25 of the baking oven 20 backwards towards the rear end 26 of the baking oven 20. Near the rear end 26 of the baking oven 20, the baking tong chain 22 is deflected by a rear baking tong chain deflecting apparatus 27 from the upper transport level 23 downwards into the lower transport level 24.

The baking tong chain 22 contains openable and closable baking tongs 28 in which baking moulds consisting of baking mould upper parts and baking mould lower parts are disposed, which baking moulds are opened by opening the baking tongs 28 and closed by closing the baking tongs 28. The baking tongs 28 each have a tong lower part 28a and a tong upper part 28b which is pivotably connected to said tong lower part. Attached to the tong upper part 28b is a control roller by which means the baking tongs 28 are opened and closed. Flat baking plates which contain the baking mould lower parts of the baking moulds are disposed in the tong lower parts 28a. Flat baking plates which contain the baking mould upper parts of the baking moulds are disposed in the tong upper parts 28b.

The baking chamber 21 is disposed in the rear oven part 20b. The baking oven 20 is provided with an electrical induction heater which provides elongate inductors 29, 30 disposed in both transport levels 23 and 24 in each case above and below the orbit of the baking tongs 28.

In the front oven part 20a of the baking oven 20, a device 31 for opening the baking tongs 28, an output station 32, a loading station 33 and a device 34 for closing the baking tongs 28 are disposed one behind the other in the running direction of the baking tongs 28 along the upper transport level 23. A product removal apparatus 35 having a horizontally disposed rotary framework 36 is disposed in the output station 32. The rotary framework 36 rotates about its horizontally disposed central axis and removes the baked products from the opened baking tongs 28a and conveys them to an upper transport device 37 which conveys the baked products out from the baking oven 20.

FIG. 3 shows schematically a third baking oven 40 from the side. The baking oven 40 has a front oven part 40a, a rear oven part 40b, an oven frame provided with an external thermal insulation 40c, a baking chamber 41 disposed inside the thermal insulation 40c and an endless baking tong chain 42 circulating continuously in the baking oven 40 and moving through the baking chamber 41. The baking oven 40 corresponds in its design structure to the baking oven 20 of FIG. 2 and only differs from this by the baking chamber heating which is configured as gas heating 43 in the baking oven 40. The gas heating 43 provides elongate gas burners 44 and 45 which are disposed in the baking chamber 41 below the orbit of the baking tong chain 42.

FIGS. 4a to 4c show a first embodiment of the horizontally disposed rotary framework of the product removal apparatus. FIG. 4a shows the rotary framework 50 in an oblique view from the rear side. FIG. 4b shows the rotary framework 50 in its working position. FIG. 4c shows the rear side of the rotary framework 50.

The rotary framework 50 is mounted rotatably at its rear side in a holding apparatus 51 fastened to the oven frame. The holding apparatus 51 is fastened in a height-adjustable manner to the oven frame. The rotary framework 50 has a horizontally disposed hollow shaft 52. The rear driving star 53 of the rotary framework 50 sits on the hollow shaft 52, said star having arms 54 arranged in a star shape, which carry rotatably mounted drive rollers 55 at their end sections, which engage in the intermediate spaces between the successive baking tongs of the circulating baking tong chain.

A vertically disposed rotary star 56 is fastened to the front end of the hollow shaft 52. The rotary star 56 is configured as a hollow body. The interior of the rotary star 56 is connected to the hollow chamber of the hollow shaft 52. The outer circumference of the rotary star 56 is configured as a polygon. Two adjacently disposed longitudinal rods 58 parallel to the hollow shaft 52 are fastened to each of the straight segments 57 of the polygon. The longitudinal rods 58 are configured as hollow profiles and each carry three removal elements 59 disposed at a distance from one another. Each removal element 59 is configured as a suction element and is connected to a negative pressure source via a suction line. The suction line runs inside the rotary framework 50 from the removal element 59 through the hollow longitudinal rod 59 and the hollow rotary star 56 to the hollow shaft 52 and through the hollow shaft 52 out from the rotary framework 50. The removal elements 59 fastened to the longitudinal rods 58 are configured as suction cups which are provided with an elastic bellows.

The two longitudinal rods 58 fastened to a straight segment 57 of the outer circumference at the rotary star 56 are disposed in a reference plane parallel to the axis of rotation of the rotary framework 50. The suction cups which are attached to both longitudinal rods 58 and are provided with an elastic bellows are disposed perpendicular to the reference plane. The two longitudinal rods 58 together form a product carrying arm of the rotary framework 50. The rotary framework 50 has nine such product-carrying arms which are disposed along the circumference of the rotary framework 50 at a distance from one another.

FIGS. 5a to 5c show a second embodiment of the horizontally disposed rotary framework of the product removal apparatus. FIG. 5a shows the rotary framework 60 in an oblique view from the rear side. FIG. 5b shows the rotary framework 60 in its working position. FIG. 5c shows the rear side of the rotary framework 60.

The rotary framework 60 is rotatably mounted in a holding apparatus 61 fastened to the oven frame. The holding apparatus 61 is fastened in a height-adjustable manner to the oven frame. The rotary framework 60 has a horizontally disposed hollow shaft 62. The rear driving star 63 of the rotary framework 60 sits on the hollow shaft 62, said star having arms 64 arranged in a star shape, which carry rotatably mounted drive rollers 65 at their end sections, which engage in the intermediate spaces between the successive baking tongs of the circulating baking tong chain.

The rotary framework 60 has two vertically disposed rotary stars 66 configured as hollow bodies, whose interior is in each case connected to the interior of the hollow shaft 62. The outer circumference of the rotary stars 66 is configured as a polygon. Respectively two removal elements 68 arranged at a distance from one another are attached to each straight segment 67 of the polygon which are configured as suction cups provided with an elastic bellows and are connected via the hollow rotary stars 66 to a negative pressure source.

FIGS. 6a to 6g show a third embodiment of the horizontally disposed rotary framework of the product removal apparatus. FIG. 6a shows the rotary framework 70 which projects into the opened baking tongs of a baking oven in an oblique view from the rear side. FIG. 6b shows the rotary framework 70 in its working position without baking tongs. FIG. 6c shows the rear side of the rotary framework 70. FIG. 6d shows the rotary framework 70 projecting into the opened baking tongs of a baking oven in a vertical section perpendicular to the axis of rotation of the rotary framework 70. FIG. 6e shows the rotary framework 70 projecting into the opened baking tongs of a baking oven in a vertical section through the axis of rotation of the rotary framework 70. FIG. 6f shows in a vertical section a product carrying arm of the rotary framework 70 in an opened baking tong above the tong lower part of the baking tong. FIG. 6g shows a side view of FIG. 6f.

The rotary framework 70 shown in FIG. 6a projects into three successive opened baking tongs 71 of a baking oven. In FIG. 6a the opened baking tongs 71 are only shown schematically. The rotary framework 70 is disposed in the opened baking tongs 71 above the tong lower parts 71a and extends with its front side as far as close to the folded-up tong upper parts 71b. The rotary framework 70 is rotatably mounted in a holding apparatus 72 fastened to the oven frame. The holding apparatus 72 is fastened in a height-adjustable manner on the oven frame. The rotary framework 70 has a short horizontal hollow shaft 73. A driving star 74 disposed on the rear side of the rotary framework 70 sits on the hollow shaft 73, said star having arms 75 arranged in a star shape, which carry rotatably mounted drive rollers 76 at their end sections, which engage in the intermediate spaces between the successive baking tongs of the circulating baking tong chain.

The rotary framework 70 provides product carrying arms 77 adjacent to its external circumference, which are disposed in the circumferential direction of the rotary framework 70 at a distance from one another and which carry removal elements 78 of the rotary framework 70 each configured as suction elements, which are disposed on the outer circumference of the rotary framework 70.

Each product carrying arm 77 has a longitudinal rod 79 parallel to the axis of rotation of the rotary framework 70. On the side of the longitudinal rod 79 pointing radially outwards in the rotary framework 70, five transverse rods 80 are provided, these being connected to the longitudinal rod 79 by a radially disposed connecting rod 81. On its side pointing radially outwards in the rotary framework 70, each transverse rod 80 carries three removal elements 78 disposed at a distance from one another. Each removal element 78 is configured as a suction cup provided with an elastic bellows, which is fastened to the transverse rod 80. The longitudinal rod 79, the five transverse rods 80 and the five connecting rods 81 are configured as hollow profiles. The longitudinal rod 79 is connected by a radial connecting pipe 82 located close to the drive star 74 to a negative pressure distributor 83 disposed at the end of the hollow shaft 73. The product carrying arm 77 carries fifteen removal elements 78 configured as suction cups, which are disposed in a plane parallel to the axis of rotation of the rotary framework 70. The fifteen suction cups are connected via suction lines running in the product carrying arm 77 to the negative pressure distributor 83. The suction lines run through the hollow transverse rods 80 and the hollow connecting rods 81 to the hollow longitudinal rod 79 and through the radial connecting pipe 82 to the negative pressure distributor 83.

The rotary framework 70 has nine product carrying arms 77 disposed at a distance from one another in the circumferential direction of the rotary framework 70. The rotary framework 70 rotates about its horizontal axis of rotation. In the region of the lower apex of the rotary framework 70 one product carrying arm 77 after the other is placed with its suction cups each provided with an elastic bellows due to the turning movement of the rotary framework 70 onto the baked product pieces which lie on the tong lower parts 71a of the opened baking tongs 71 passing the lower apex of the rotary framework 70.

FIGS. 7a to 7d show a product-carrying arm 77 of the rotary framework 70. FIG. 7a shows the product carrying arm 77 from the side, FIG. 7b shows it in front view, FIG. 7c from above and FIG. 7d in an oblique view.

FIGS. 8a to 8d show another embodiment of the rotary framework of the product removal apparatus in engagement with a circulating baking tong chain of a baking oven. FIG. 8a shows three successive opened baking tongs of a baking tong chain with the rotary framework projecting into the opened baking tongs from the rear side. FIG. 8b shows an oblique view of FIG. 8a. FIG. 8c shows the engagement of the rotary framework in the baking tong chain. FIG. 8d shows an oblique view of FIG. 8c.

The rotary framework 85 shown in FIGS. 8a and 8b projects into three successive opened baking tongs 86 of an endless baking tong chain of a baking oven. In FIGS. 8a and 8b the opened baking tongs 86 are only shown schematically. The rotary framework 85 is disposed above the tong lower parts 86a in the opened baking tongs and extends with its front side as far as close to the folded-up tong upper parts 86b. The rotary framework 85 is rotatably mounted at its rear side in a holding apparatus 87 fastened to the oven frame. The holding apparatus 87 is attached in a height-adjustable manner on the oven frame. The rotary framework 85 possesses a drive star 88 disposed on the rear side of the rotary framework 85 which has arms 89 arranged in a star shape, which carry rotatably mounted drive rollers 90 at their end sections, which engage in intermediate spaces located in the baking tong chain between the tong lower parts 86a of the baking tongs 86. At the baking tongs 86 the tong lower parts 86a are provided at the front and rear edges with strips 91, 92 projecting beyond the tong lower parts 86a, against which the drive rollers 90 of the rotary framework 85 abut.

FIGS. 9a to 9d show a removal element of the rotary framework which is configured as a suction sleeve which is elastically compressible into itself. FIG. 9a shows the suction sleeve from the side, FIG. 9b shows a vertical section through the suction sleeve, FIG. 9c shows the suction sleeve in oblique view and FIG. 9d shows a plan view of the suction sleeve. The suction sleeve 94 has two coaxial pipe pieces 94a and 94b which can be slid telescopically into one another and a compression spring 95 which slides the two pipe pieces 94a and 94b apart in the interior of the suction sleeve 94. The inner pipe piece 94b carries a suction plate 96 disposed at the free end of the suction sleeve 94.

FIGS. 10a to 10d show a removal element of the rotary framework which is configured as a suction cup 97 provided with an elastic bellows 96. FIG. 10a shows the suction cup from the side, FIG. 10b shows a vertical section through the suction cup, FIG. 10c shows the suction cup in oblique view and FIG. 10d shows a plan view of the suction cup.

1-18. (canceled)

19. A baking oven for producing baked products, the baking oven comprising:
a front oven part, a rear oven part, an oven frame with an external thermal insulation, and a baking chamber formed inside said thermal insulation;
an endless baking tong chain circulating continuously in the baking oven and moving through said baking chamber, said baking tong chain being disposed along an orbit that is closed in itself and that extends in two transport levels disposed one above the other through said front and rear oven parts;
said baking tong chain carrying openable and closable baking tongs with baking molds consisting of baking mold upper parts and baking mold lower parts disposed to be opened by opening said baking tongs and to be closed by closing said baking tongs;
an opening device for opening said baking tongs in said front oven part along the upper transport level, followed by an output station, a loading station and a closing device for closing said baking tongs disposed consecutively in a running direction of said baking tongs;
a product removal apparatus disposed in said output station for removing baked products from opened said baking tongs and followed by an upper transport device for the removed baked products, said product removal apparatus having a horizontally disposed rotary framework rotatably mounted about a horizontal axis of rotation, which projects into the opened baking tongs;
said rotary framework carrying removal elements disposed along an outer circumference thereof and disposed consecutively on an outer circumference of said rotary framework in at least one longitudinal row extending along the circumference of the rotary framework;
said removal elements being suction elements connected to a negative pressure source.

20. The baking oven according to claim 19, wherein the horizontally disposed rotary framework is height-adjustably mounted in said front oven part and said horizontally disposed rotary framework has outwardly projecting drive lugs on the outer circumference thereof, which in the baking tong chain engage in intermediate spaces disposed between said baking tongs of said baking tong chain.

21. The baking oven according to claim 19, wherein said rotary framework has at least two product carrying arms disposed along the circumference of the rotary framework at a distance from one another, and wherein each said product carrying arm carries at least one removal element configured as a suction element.

22. The baking oven according to claim 21, wherein one of said product carrying arms has at least one rod which carries at least two removal elements configured as suction elements which are disposed along said at least one rod at a distance from one another.

23. The baking oven according to claim 21, wherein one of said product carrying arms has at least one longitudinal rod disposed parallel to an axis of rotation of said rotary framework, which carries at least one removal element configured as a suction element.

24. The baking oven according to claim 23, wherein said longitudinal rod carries at least two removal elements configured as suction elements, which are disposed along the longitudinal rod at a distance from one another.

25. The baking oven according to claim 23, wherein one of said product carrying arms has at least two longitudinal rods disposed parallel to an axis of rotation of said rotary framework, which are disposed in a reference plane parallel to the axis of rotation of said rotary framework and said longitudinal rods carry removal elements configured as suction elements, which are disposed perpendicular to the reference plane.

26. The baking oven according to claim 21, wherein one of said product carrying arms has a longitudinal rod disposed parallel to the axis of rotation of said rotary framework, which carries at least one transverse rod disposed transversely to said longitudinal rod, which is disposed in a reference plane parallel to the axis of rotation of said rotary framework, and said transverse rod carries two or more removal elements configured as a suction element, which are disposed along said transverse rod at a distance from one another.

27. The baking oven according to claim 26, wherein said longitudinal rod carries two or more transverse rods disposed at a distance from one another, which are disposed in a reference plane parallel to the axis of rotation of said rotary framework, and each transverse rod carries at least two removal elements configured as a suction element, which are disposed along the transverse rod at a distance from one another and are in each case disposed perpendicular to the reference plane.

28. The baking oven according to claim 21, wherein one of said product carrying arm has at least two longitudinal rods disposed parallel to the axis of rotation of said rotary framework, which are disposed in a reference plane parallel to the axis of rotation of the rotary framework, and said product carrying arm has at least two transverse rods disposed transversely to said longitudinal rods, which each carry at least two removal elements configured as a suction element, which are disposed along the transverse rod at a distance from one another and are disposed in each case perpendicular to the reference plane.

29. The baking oven according to claim 21, wherein said product-carrying arms are configured as hollow profiles and form a part of suction lines leading from said as suction elements, which are attached to said product-carrying arms, to a negative pressure source.

30. The baking oven according to claim 21, wherein said removal elements disposed on the circumference of said rotary framework are configured as suction cups attached to said product carrying arms and connected via suction lines to the negative pressure source.

31. The baking oven according to claim 30, wherein said suction cups are each provided with an elastic bellows.

32. The baking oven according to claim 21, wherein said removal elements disposed on the circumference of said rotary framework are suction sleeves that can be compressed elastically into themselves, which are attached to the product carrying arms and are connected via suction lines to the negative pressure source.

33. The baking oven according to claim 19, wherein one of the following is true:
said horizontally disposed rotary framework includes at least one vertically disposed rotary star carrying said removal elements configured as suction elements, which are disposed on the circumference of said rotary framework; or
said horizontally disposed rotary framework includes two or more rotary stars disposed adjacent one another at a spacing distance and carrying said removal elements configured as suction elements disposed on the circumference of said rotary framework.

34. The baking oven according to claim 33, wherein said vertically disposed rotary star has an outer circumference configured as a polygon with straight segments, and said removal elements configured as suction elements are disposed on said straight segments.

35. The baking oven according to claim 34, wherein two or more said removal elements configured as suction elements are respectively disposed at a spacing distance from one another on said straight segments of the outer circumference.

36. The baking oven according to claim 34, wherein said rotary star is a hollow body forming a part of a suction line leading from said removal elements configured as suction elements to the negative pressure source.

37. The baking oven according to claim 34, wherein said removal elements of said rotary framework are suction cups each provided with an elastic bellows attached to the outer circumference of said rotary star and connected via suction lines to the negative pressure source.

38. The baking oven according to claim 34, wherein said removal elements of said rotary framework are suction sleeves that are laterally compressible into themselves, attached to the outer circumference of said rotary star and connected via suction lines to the negative pressure source.
